(19) United States
(12) Patent Application Publication
(10) Pub. No.: US 2013/0007828 A1
(43) Pub. Date: Jan. 3, 2013

(54) Presentation of User Alert with Extraneous Information on Electronic Device

(75) Inventors: Thomas F. Kister, Chalfont, PA (US); Alexander N. Kokhanyuk, Hoschton, GA (US)

(73) Assignee: MOTOROLA MOBILITY, INC., Libertyville, IL (US)

(21) Appl. No.: 13/173,501

(22) Filed: Jun. 30, 2011

(51) Int. Cl. H04N 7/173

(52) U.S. Cl. 725/114

(57) ABSTRACT

An electronic device associated with a particular user includes a controller coupled to a display interface and to a receiver. The controller is configured to present a visual image on the display interface of the electronic device, and to present a foreground image on the display interface upon receipt of information indicative of a communication for the user associated with the electronic device, wherein the foreground image includes information indicative of the communication for the user associated with the electronic device and extraneous information.

### FIELD OF THE DISCLOSURE

The present disclosure relates generally to the presentation of information on a user interface of an electronic device and, more particularly, to the presentation of user alerts with extraneous information and corresponding methods.

### BACKGROUND

The digitization of information, increasing availability of broadband communications networks, and developments in digital rights management are driving the convergence and integration of services provided over data and communications networks. Many consumers now subscribe to scheduled programming (e.g., broadcast television), data communications (e.g., high speed Internet) and communications (e.g., VoIP) services over one or more such networks. For example, a cable or satellite service subscriber may receive programmed content via a set top box (STB) connected to a television or other video monitoring device. An STB may also include digital video recorder (DVR) functionality. Subscribers may receive data connectivity service, e.g., Transmission Control Protocol/Internet Protocol (TCP/IP), over a data network via a modem connected to a computer or other digital computing device for uploading and downloading data. Networks capable of providing these and other services are ubiquitous and include but are not limited to cable, ISDN, satellite and cellular data networks and copper telephone systems, all of which are typically operated by multiple system operators. Content can also be streamed from content servers over data networks onto personal computers or other digital content consumption devices, usually on a subscription basis from third party providers. For example, NETFLIX and other content providers stream content over data networks to subscriber devices like computers and networked televisions. A television may be connected to a data network via a connection to a networked device, like a DVR, Blue Ray DVD player, set top box, etc. Some newer digital televisions include integrated network connectivity hardware and functionality, which permits a direct network connection.

Consumers can now subscribe to Voice over IP (VoIP) call service using a voice modem interconnecting a telephone system and communication network. In TCP/IP networks, the voice modem interconnects a telephony system and an Internet modem connected to a data network. VoIP communication services are now provided by many multi system operators, like COMCAST and TIME WARNER among others, bundled with a high speed data service and possibly a scheduled program service. VoIP and teleconferencing services are also available from independent providers, like VONAGE, for monthly or annual fees. VoIP calling/teleconferencing services are also available by executing an application on a networked personal computer. One such application by SKYPE permits VoIP calling/teleconferencing services.

The various aspects, features and advantages of the invention will become more fully apparent to those having ordinary skill in the art upon careful consideration of the following Detailed Description thereof with the accompanying drawings described below. The drawings may have been simplified for clarity and are not necessarily drawn to scale.

### BRIEF DESCRIPTION OF THE DRAWINGS

FIG. 1 is a schematic communication diagram among various entities linked by a data network.

FIG. 2 is a schematic block diagram of an exemplary set top box (STB).

FIG. 3 is a schematic diagram of a process implemented in an electronics device.

### DETAILED DESCRIPTION

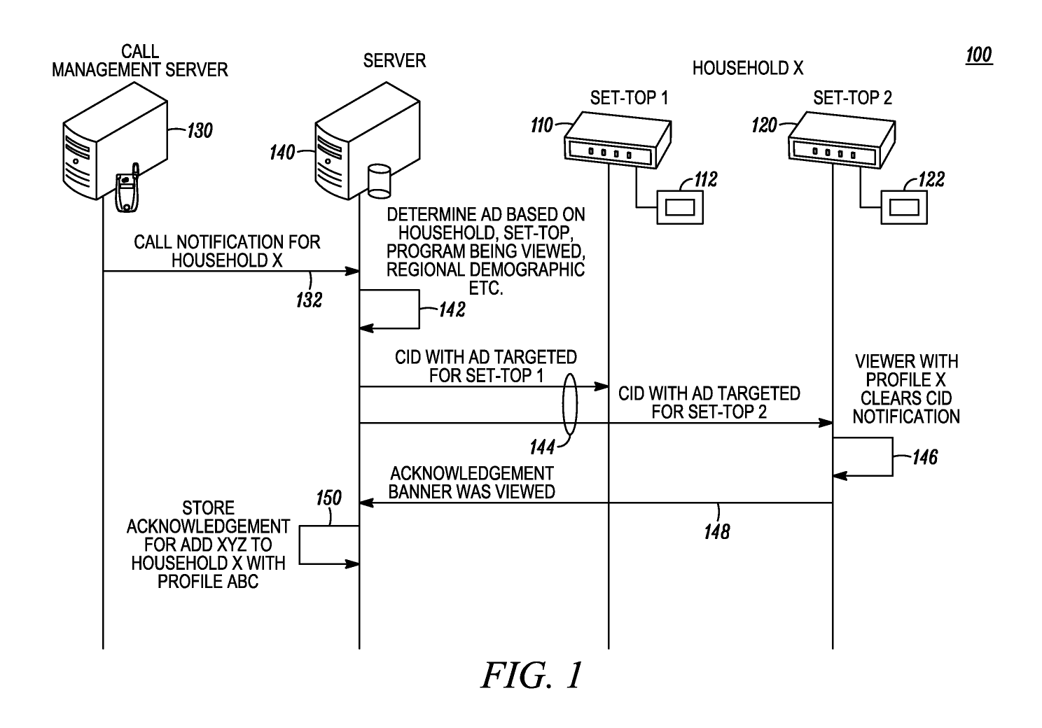

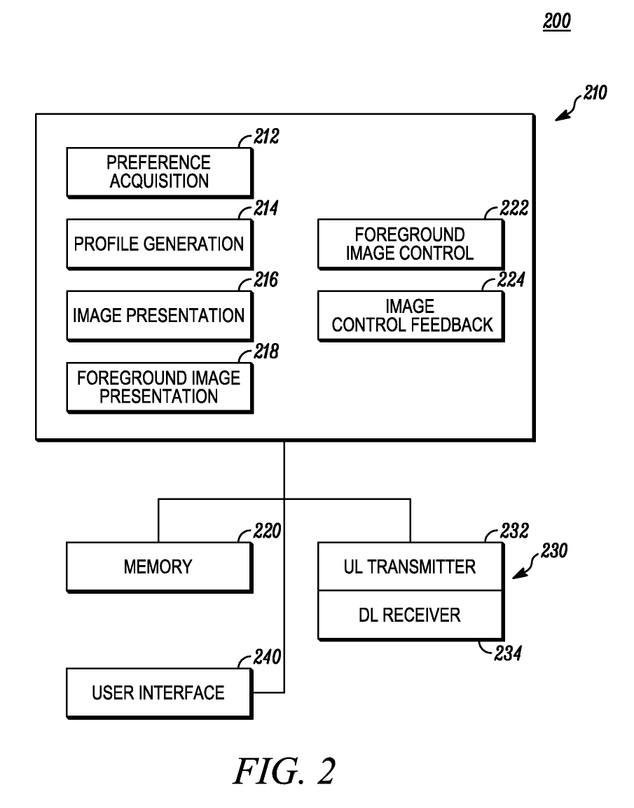

In FIG. 1, an electronic device is connected to a data network over which the device receives programming or content and communications from various entities as described further below. In FIG. 2, an electronic device 200 generally comprises a controller 210 coupled to memory 220 and to one or more modems or transceivers 230. The transceivers may be implemented as a wireless or wire-line modem or a combination thereof. The processor is also coupled to a user interface 240, which may be in the form of a visual display or an audio interface or a combination thereof. The user interface may or may not be integrated, depending on the particular implementation of the electronic device, examples of which are described further below. The processor is typically implemented as a digital processor that executes firmware or an instruction set stored in memory to perform various functions of the electronic device, which functions are described more fully below. Alternatively, the processor may be implemented as an equivalent analog circuit or as a combination of analog and programmed digital circuits.

Networks capable of supporting communications and data services with and for electronic devices are ubiquitous and include local or wide area networks and combinations thereof. Such networks include but are not limited to Ethernet, Integrated Services Digital Network (ISDN), Digital Subscriber Line (DSL), transmission Control Protocol/Internet Protocol (TCP/IP), any one of a variety of cellular network protocols among many other protocols. Such networks may be open or proprietary. The present disclosure is not limited to these or any other presently known or future networks or communication protocols. Such networks are well known to those of ordinary skill in the art and are not described further herein except to the extent necessary to enable the best mode of the disclosure. These and other contemplated networks are typically operated by a multiple system operator (MSO), but more generally the network may be operated by a private, institutional or governmental entity.

The exemplary electronic device is embodied as set top box (STB) combined with a video monitor or display device. In this embodiment, at least the STB or the monitor includes a tuner. In some embodiments both the STB and monitor include a tuner. The STB may be connected to a data network wirelessly or by a wire-line. The STB generally enables reception of downlink (DL) signals by the tuner or receiver of the STB, television or video monitor. For example, the STB may enable reception of digital signals, or perform descrambling of content, for example premium cable or satellite channels. Some set top boxes also perform signal conversion to enable reception of signals that would otherwise be outside a frequency band of the tuner. These and other functional features of set top boxes are known generally and thus the details thereof are not described further herein

In FIG. 1, a first set top box (STB) 110 is associated with a first television monitor 112 and a second STB 120 is associated with a second television monitor 122 on which content may be consumed. The first and second STBs are shown associated with a single household or common subscriber, but generally each STB may be associated with a corresponding user or subscriber. In FIG. 1, the multiple STBs associated with the common household may also be associated with separate users, as described further below. A MSO typically leases an STB to a subscriber but subscribers may also purchase the device.

Alternatively, without limitation, the electronic device may be embodied as a network enabled television, personal computer, gaming station, laptop or tablet, smart phone, consumer premise equipment (CPE) or any other residential or commercial communication or media consumption device having a user interface and a wired or wireless data network interface. The electronic device, of whatever form, is generally connected to the data network using a modem or transceiver. For example, a laptop computer or gaming device may be connected to a data network by a modem (e.g., TCP/IP cable modem), a wireless (e.g., WiFi) modem, a cellular (e.g., 3GPP LTE) modem, or some other wired or wireless data transceiver that communicates pursuant to an extant of future protocol modem. In general the electronic device is connected to a broadband network delivering content and/or services and the device is capable of bi-directional communications over the network. Communications from the electronic device to one or more external service platforms and to electronic devices may originate on-demand in an asynchronous matter, for instance driven by events associated with delivery of extraneous information or 3rd party services support.

In FIG. 2, the electronic device 200 includes uplink (UL) transmission functionality 232. In some but not all embodiments the device includes downlink (DL) reception functionality 234. For example, transmission of uplink (UL) communications in an STB may enable communications associated with on-demand features, online commerce activities, or user preference acquisition as discussed further below. Generally, the electronic device may not include all of the features or functionality illustrated in FIG. 2. For example, some embodiments of the electronic device do not transmit on the uplink.

In some embodiments, the electronic device is also configured with functionality to acquire preference information of the user or subscriber. The acquired preference information may be used to create a user profile. The preference information includes user usage patterns and behavior among other metrics from which a user profile may be created. In FIG. 2, the electronic device includes user preference acquisition functionality 212. The user preference acquisition functionality may be readily implemented by the execution of firmware or software by the controller. The creation of the user profile may occur at the STB or other electronic device. In FIG. 2, the STB also includes user profile generation functionality 214 wherein a user profile is generated based on the preferences of the user. Alternatively, the profile may be created at another location, for example, at a remote server upon receipt of user preference information provided by the STB. In these alternative embodiments, the electronic device may provide the user preference information to the server periodically or on an ad hoc basis. In some embodiments, the user profile is created at the server. In embodiments where the STB generates user profile, the STB may also send the profile information to the server. Generally, a user profile that is based on user preference information may be updated based on new or updated preference information. The profile updates may be performed at the electronic device or at the server, depending on where the profile is generated. The preference information or the user profile may be stored in memory on the electronic device or the server. The acquisition of user preference information and the generation of user profiles are well known generally and are not described further herein. The present disclosure is not limited to any particular method for obtaining user preference information or generating a user profile except to the extent indicated herein. Thus the acquisition of user preference information and the generation of a user profile from the preference information is not described further herein. Various use cases are described in some of the alternative embodiments below.

Generally, the electronic device is associated with a particular user. For example, the electronic device may be associated with a user by virtue of the user logging-into the device or by virtue of a subscription for services possessed by the user or by a combination thereof. The service subscription could be associated with access to a data network or an access point or some other communications network. The service subscription may also be for access to content or for access to a service. Thus generally a particular user may have multiple subscriptions. In one embodiment, the user may have one subscription for access to a data network and another subscription for access to content, e.g., a NETFLIX account, received over the network. In another scenario, the user may have a subscription for access to a data network and another subscription for access to a service like a VoIP service provided over the data network. Generally, each service provider may acquire user preference information associated with the corresponding account possessed by the user. For example, the content provider may acquire the user preferences for content genre, viewing time and duration etc, whereas a VoIP provider may acquire preference information related to call destination, time and duration, etc. More generally, multiple users having separate accounts (e.g., accessible using unique passwords) may access a data network under a common subscription. In FIG. 1, for example, the first STB may be associated with a first householder user and the second STB may be associated with a second household user. The associations could be made by virtue of user login information or by any other mechanism. In such circumstances, separate preference information may be acquired and a profile generated for each user. And to the extent that the separate users are associated with a common household or master account, preferences may also be generalized for the master account based on the individual users.

In the particular architecture of FIG. 1, the household may have a subscription to receive programmed television content via the first STB or the second STB. In this case the household is considered the user. Thus generally a user may relate to a single user or to a group of users, for example a group of users associated with a household. An STB is generally enabled upon payment of the subscription fee, but in some instances the STB may also be password protected or partially password protected. For example, some content (e.g., television channels or “M” rated content, which may be available on-demand content) received by the STB may be password protected and other content received by the STB are not be protected.

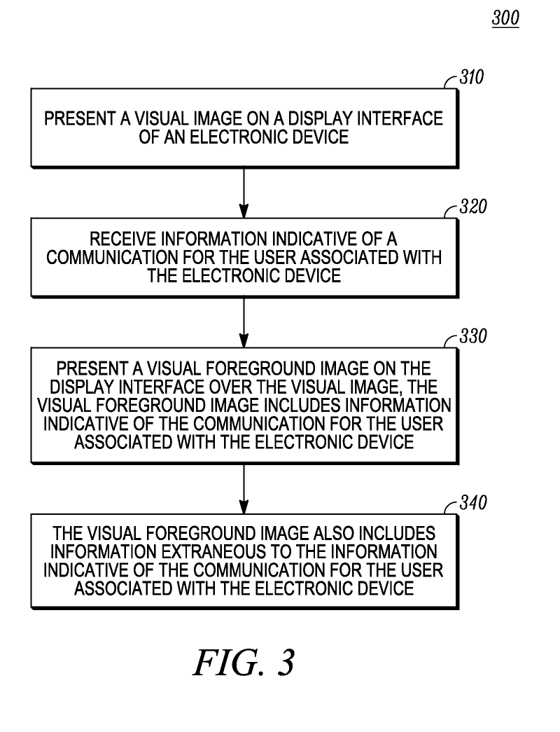

In the process diagram 300 of FIG. 3, at block 310, a visual image is presented on a display interface of an electronic device. In one embodiment, the visual image is content obtained over a data network. In FIG. 2, the controller 210 includes image presentation functionality 216 which may be implemented by a digital processor executing firmware or some other instruction set stored in memory

In FIG. 1, for example, either or both the first STB 110 and the second STB 120 may present content obtained from a server or other source on the corresponding monitor 112, 122. In one embodiment, the content is programmed content provided by an MSO. In another embodiment, the visual image is presented on the monitor of a computing device wherein the content is streamed from a content server. For example, a user of a personal computing device may download streamed content from a content provider or server using a web browser. In another embodiment, the visual image is content streamed to a networked television from a content provider like NETFLIX or from some other content server. Alternatively, the visual image presented on a display interface of the electronic device could be content that is obtained from a local source. Such locally obtained content may be obtained from a repository like an internal or external memory device of the electronic device. Alternatively, the locally obtained content may be obtained from media removably coupled to the device. Exemplary media includes DVD and solid state Flash memory drives. In another embodiment, the visual image is information displayed on a monitor of the device wherein the information is associated with an application that is executed by a processor of the electronic device. Those skilled in the art will appreciate that the present disclosure contemplates many scenarios by which a visual image is or may be presented on the user interface of an electronic device and that the disclosure is not limited to the specific examples described herein.

In FIG. 3, at block 320, the electronic device receives information indicative of a communication for the user associated with the electronic device. In FIG. 2, such a communication is received by the transceiver and more particularly by the DL receiver 234 thereof. In one embodiment, the information indicates that a communication for the user associated with electronic device has been sent to, or possibly received, by a device other than the electronic device. For example, the communication sent to the other device could be a voice call sent to a telephone like a cell phone or a landline phone. In one embodiment, the information indicative of the communication for the user associated with the electronic device includes information identifying an originator of the communication for the user associated with the electronic device.

In FIG. 1, a communication management server 130 sends a call notification to the first and second set top boxes, via an optional advertisement server described further below, for presentation of an indication on the monitors as discussed below. In one embodiment, the user of the STB in FIG. 1 is also a subscriber to a VoIP communication service provided over the same data network over which the STB obtains the content that is presented on the monitor. As suggested above, some system operators offer bundled television, data and VoIP calling services. Some operators also offer bundled services and cellular communication service. Thus the bundled service provider can transmit the communication indicator signal to the STB upon receipt of the communication for the user on the cellular or VoIP system. In response, the electronic device causes a prompt to be displayed on a user interface as described more fully below.

If the cellular service provider and the STB content provider are the same, the common service provider could communicate the communication indicator directly to the STB for presentation on the monitor. In some embodiments, the communication service provider is different than the STB service provider. For example, the STB subscriber or user may obtain VoIP or cellular communication service from another provider. In these circumstances, some business cooperation is required for the communication service provider to forward the communication indication to the STB for presentation on the monitor.

Besides voice communications described above, the communication indicator could be indicative of a communication on a device other than a cell phone or a landline. Other communications include but are not limited to video calls, text messages, chat messages, instant messages and email among other messages or communications. These other communications could be received on other devices like a computer or smart phone among other devices specified herein. The communication indicator could also indicate that the user has received a call on the same device on which the visual image is presented.

In another embodiment, the electronic device is a networked television connected to the data network by a network modem or adapter. Some newer televisions have integrated networking functionality that permits connection to a data network by a wireless or wire-line interface. Alternatively, the television may be interconnected to the data network by a networked device like a Blu-ray player or some other intermediate network capable device. In another embodiment, the electronic device is a computing device having a network interface. In these alternative embodiments, the visual image, from whatever source, is presented on the electronic device.

In FIG. 3, at block 330, a foreground image is presented on the display interface of the electronic device. The foreground image includes information indicative of the communication for the user associated with the electronic device. In FIG. 2, the controller 210 includes foreground image presentation functionality 218 which may be implemented by a digital processor executing firmware or other instruction set stored in memory. The foreground image is presented at least partially over the visual image. For example, the foreground image could appear as a watermark such that the visual image is at least partially visible through the foreground image. Thus the foreground image either fully or partially obscures a portion of the visual image over which it is presented.

In some embodiments, the information indicative of the communication for the user associated with the electronic device includes information identifying an originator of the communication. Such information may include a name of address or number of the originating caller. The foreground image presented on the display interface. The foreground image is generally presented after or in response to receipt of the communication indicating the receipt of the communication for the user. The image may be temporary or persistent. Thus the foreground information presented on the display interface of the electronic device provides a visual notification to the user of the existence of a voice call or other communication. For the case where the communication is a voice call or a video conference call, the foreground image may be presented while the communication is pending such that the user may accept the incoming call and carry on a voice or video conference. For these and other active communication sessions, the information indicative of the communication is received and the foreground image is received in relative real-time. Here, real-time means that there is sufficient time for a prompt user to engage in a call or other communication session before the call is terminated for lack of acceptance. Other communications are inactive, meaning that there is no active session in which the user can participate or accept. For example, an inactive communication notification may be indicative of a missed voice call, a received email, etc.

According to another aspect of the disclosure, the foreground image includes information extraneous to the information indicative of the communication for the user associated with the electronic device. Generally, the extraneous information is unrelated to the information indicative of the communication sent to the user. In one embodiment, the extraneous information is an advertisement, for example, a banner. The banner could be static or it could be a dynamic video image. Alternatively, the extraneous information is some other information unrelated to the information indicative of the communication for the user. In embodiments where a visual image is presented on the display interface, the banner ad is superimposed on the visual image. In one implementation, a visual solicitation is presented simultaneously with information identifying the originator of the communication.

In one embodiment, the extraneous information is based on a preference of the user associated with the electronic device. The user preference may be in the form of a user profile. In the architecture of FIG. 1 for example one or both STBs provide user preference or profile information to a server 140, which stores the information. In FIG. 1, at 132, the communication management server 130 sends a communication notification for a particular user to the server 140. At 142, the server then identifies or selects extraneous information, for example, an advertisement, specifically tailored for the user based on user preference or profile information stored on the server. The latter information may also identify the originator or some other characteristic of the communication as discussed above. At 144, the server sends information indicative of the communication including the extraneous information to the first STB 110 and the second STB 120. Generally, such information is sent to at least one electronic device. Thereafter, the electronic device displays the foreground information including the communication indication and the extraneous information on the monitor, as described above.

In an alternative embodiment, electronic device identifies or selects extraneous information, for example, an advertisement, for the user based on user preference or profile information stored on the electronic device. According to this embodiment, the electronic device receives advertisements or other extraneous information from some other source, like an ad server. These ads are stored on the electronic device for later selection and display with the information indicative of the communication for the user associated with the electronic device. The ad server could perform preliminary filtering of the ads sent to the electronic device based on user preference or profile information provided to the ad server. Alternatively, the ad server could send ads to the STB without the use of user preference or profile information provided by the STB. For example, the ads could be based on general information about the user, like residential zip code information or based on some other information.

According to another aspect of the disclosure, the user may manipulate the foreground image displayed on the user interface. This aspect requires that the electronic device enable interactive user input. In FIG. 1, the STB provides a user interface enabling the user to manipulate or control displayed images via a control device, like a remote control. Similarly, in embodiments wherein the electronic device is implemented as a personal computing device, the user may interact with a graphical user interface using a mouse, touch or other type of input. According to this aspect of the disclosure, in FIG. 1 at 146, the user can control or manipulate the foreground image or at least a portion thereof. For example, the user may cause the image to be removed in part or fully by providing some input to electronic device. Alternatively, the user may move the image to a different portion of the display interface. The user may also minimize the image such that it does not appear on the display. In FIG. 2, the controller includes foreground image control and manipulation functionality 222 in response to a command received from the user. This functionality may be implemented by a digital processor executing firmware or some other instruction set stored in memory.

According to a related aspect of the disclosure, in FIG. 1 at 148, the electronic device provides feedback to a server wherein the feedback indicates whether the user has observed or viewed the extraneous information based on whether the user has manipulated the foreground image. In one embodiment, the electronic device sends a message to a server, for example, the ad server 140 in FIG. 1, in response to or upon receiving a command from the user to manipulate the foreground image. In FIG. 2, the controller includes foreground image control reporting functionality 224, which may be implemented by a digital processor executing firmware or some other instruction set stored in memory. In FIG. 1 at 150, the server stores information fed back by the electronic device. Such feedback may be useful to determine whether a user has received and been subjected to an ad and to gauge the effectiveness of an advertising campaign.

While the present disclosure and the best modes thereof have been described in a manner establishing possession and enabling those of ordinary skill to make and use the same, it will be understood and appreciated that there are equivalents to the exemplary embodiments disclosed herein and that modifications and variations may be made thereto without departing from the scope and spirit of the inventions, which are to be limited not by the exemplary embodiments but by the appended claims.

What is claimed is:

1. A method in an electronic device associated with a user, the method comprising:
presenting a visual image on a display interface of the electronic device;
receiving information indicative of a communication for the user associated with the electronic device;
presenting a foreground image on the display interface, the foreground image presented at least partially over the visual image,
the foreground image including information indicative of the communication for the user associated with the electronic device, and
the foreground image including extraneous information that is extraneous to the information indicative of the communication for the user associated with the electronic device.

2. The method of claim 1, the information indicative of the communication for the user associated with the electronic device indicates that the communication for the user associated with the electronic device has been sent to a device other than the electronic device.

3. The method of claim 1, wherein the extraneous information is based on a preference of the user associated with the electronic device.

4. The method of claim 1,
receiving information indicative of the communication for the user associated with the electronic device includes receiving information identifying an originator of the communication for the user associated with the electronic device,
presenting the foreground image on the display interface includes presenting information identifying the originator of the communication.

5. The method of claim 4, the information indicative of the communication for the user associated with the electronic device indicates that the communication for the user associated with the electronic device has been sent to a device other than the electronic device.

6. The method of claim 4,
receiving information indicative of the communication sent to the user associated with the electronic device includes receiving visual solicitation information,
presenting the foreground image on the display interface of the electronic device includes simultaneously presenting the visual solicitation and the information identifying the originator of the communication.

7. The method of claim 1,
receiving, at the electronic device, a user command instructing manipulation of at least a portion of the foreground image from the display interface,
communicating, from the electronic device, information indicative that the extraneous information was viewed by the user associated with the electronic device based on the command instructing manipulation of at least a portion of the foreground image.

8. The method of claim 1,
presenting the visual image on the display interface of the electronic device includes presenting video content,
wherein the extraneous information includes a banner superimposed on the video content.

9. The method of claim 1, receiving the extraneous information with the information indicative of the communication for the user associated with the electronic device.

10. The method of claim 3 further comprising:
obtaining information about the user associated with the electronic device;
transmitting the information obtained,
wherein the preference of the user associated with the electronic device is based on the information obtained.

11. An electronic device associated with a particular user, the device comprising:
a display interface;
a receiver;
a controller coupled to the display interface and to the receiver,
the controller configured to present a visual image on the display interface of the electronic device,
the controller configured to present a foreground image on the display interface upon the receiver receiving information indicative of a communication for the user associated with the electronic device,
the foreground image including information indicative of the communication for the user associated with the electronic device,
the foreground image including extraneous information that is extraneous to the information indicative of the communication for the user associated with the electronic device.

12. The device of claim 11, the information indicative of the communication for the user associated with the electronic device indicates that the communication for the user associated with the electronic device has been sent to a device other than the electronic device.

13. The device of claim 11, wherein the extraneous information is based on a preference of the user associated with the electronic device.

14. The device of claim 11,
the information indicative of the communication for the user associated with the electronic device includes information identifying an originator of the communication for the user associated with the electronic device,
the foreground image presented on the display interface includes information identifying the originator of the communication.

15. The device of claim 14, the information indicative of the communication for the user associated with the electronic device includes information indicative that the communication for the user associated with the electronic device has been sent to a device other than the electronic device.

16. The device of claim 14,
the information indicative of the communication sent to the user associated with the electronic device includes visual solicitation information,
the foreground image presented on the display interface of the electronic device includes the visual solicitation and the information identifying the originator of the communication.

17. The device of claim 11 further comprising a transmitter,
the controller configured to manipulate the foreground image in response to a command from the user associated with the electronic device,
the controller configured to cause the transmitter to communicate information indicating that the extraneous information was viewed by the user associated with the electronic device based on the command instructing manipulation of the foreground image.

18. The device of claim 17, the receiver includes a first receiver and a separate second receiver.

19. The device of claim 11,
the visual image presented on the display interface of the electronic device includes video content,
the extraneous information includes a banner superimposed on the video content.

20. The device of claim 12 is customer premise equipment and the other device is a telephone.
